(19) United States
(12) Patent Application Publication
(10) Pub. No.: US 2005/0052461 A1
(43) Pub. Date: Mar. 10, 2005

(54) Method for dressing and animating dressed characters

(75) Inventors: Tzvetomir Ivanov Vassilev, Rousse (BG); Chrysanthou Yiorgos Lambros, Nicosia (CY); Bernhard Spanlang, London (GB)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: UNIVERSITY COLLEGE LONDON

(21) Appl. No.: 10/486,842

(22) PCT Filed: Aug. 8, 2002
(86) PCT No.: PCT/GB02/03632

(30) Foreign Application Priority Data
Aug. 16, 2001 (GB) 0120039.3

(51) Int. Cl. G06T 15/70

(52) U.S. Cl. 345/473

(57) ABSTRACT

A method of dressing 3D virtual beings and animating the dressed beings for visualisation, the method comprising the steps of: positioning one or more garment pattern around a body of a 3D virtual being; applying, iteratively, to the pattern elastic forces in order to scam the garment; and once the garment is scanned, causing the body to carry out one or more movements, wherein the overstretching of cloth within the garment is prevented by the modification of the velocity, in the direction of cloth stretch, of one or more points within the garment. The present invention provides a fast method for dressing virtual beings and for visualising and animating the dressed bodies, and a system for carrying out the method.

This invention relates to a method for modelling cloth, for dressing a three-dimensional (3D) virtual body with virtual garments and for visualising and animating the dressed body.

There are existing systems for shopping for clothing on the Internet, for example. However, none of them offer a three-dimensional (3D) virtual dressing room in which customers can see an accurate virtual representation of their body, try on items of clothing, look at the resulting image from different viewpoints, and animate the image walking on a virtual catwalk. The speed of developments in 3D scanning technology will soon allow major retailers to have 3D scanners in high-street stores, like Marks & Spencer (RTM) do at the moment. Customers will be able to go in, scan themselves and get their own 3D body on a disk or smart card or other such media storage device. Then they can use their virtual representation to buy clothes from home on the Internet, or in the store using an electronic kiosk. Due to the accuracy of 3D scanning technology it will be possible not only to try on different types of clothes, but also to assess the fit of different sizes. However, in order to make this happen, fast methods for cloth modelling and animation need to be developed, which is the aim of this invention.

Physically based cloth modelling has been a problem of interest to researchers for more than a decade. First steps, initiated by Terzopoulos et al. [Terzopoulos D. Platt J. Barr A. and Fleischer K., Elastically Deformable Models. Computer Graphics (Proc. SIGGRAPH 1987); 21 (4): 205-214, and Terzopoulos D. and Fleischer K., Deformable Models, Visual Computer 1988; 4: 305-331], characterised cloth simulation as a problem of deformable surfaces and used the finite element method and energy minimisation techniques borrowed from mechanical engineering. Since then other groups have been formed which have attempted cloth simulation using energy or particle based methods.

Breen et al. [Breen D. E., House D. H. and Wozhny M. J., Predicting the drape of woven cloth using interacting particles, Computer Graphics (Proc. SIGGRAPH 1994); 28:23-34], used interacting particles to model the draping behaviour of woven cloth. This model can simulate different fabric types using Kawabata plots as described in “The Standardization and Analysis of Hand Evaluation”, by S. Kawabata, The Textile Machinery Society of Japan, Osaka, 1980, but it takes hours to converge. Eberhardt et al. [Eberhardt B. Weber A. and Strasse W., A fast, flexible, particle-system model for cloth-draping, IEEE Computer Graphics and Applications 1996; 16:52-59], developed further Breens's model, extending it to air resistance and dynamic simulations. Its speed, however, was still slow. Thalmann's team presented a method for simulating cloth deformation during animation [Carignan M. Yang Y. Magnenat-Thalmann N. and Thalmann D., Dressing animated synthetic actors with complex deformable clothes, Computer Graphics (Proc. SIGGRAPH 1994); 28:99-104] based on Terzopoulos' equations. Baraff and Witkin [Baraff D. and Witkin A., Large Steps in Cloth Simulation, Computer Graphics (Proc. SIGGRAPH 1998); 43-54] also used Terzopoulos' model, combining it with a numerical method for implicit integration which allows them to take larger time steps. A more detailed survey on cloth modelling techniques can be found in the paper by Ng and Grimsdale [Ng N. H. and Grimsdale R. L., Computer graphics techniques for modelling cloth, IEEE Computer Graphics and Applications 1996; 16:28-41].

Many of the approaches described above have a good degree of realism in simulating cloth, but their common drawback is low speed. A relatively good result, demonstrated by Baraff and Witkin, is 14 seconds per frame for the simulation of a shirt with 6,450 nodes on a SGI R10000 processor. This means that to dress a shirt on a human body will take several minutes, which is unacceptable. This is the main reason why these techniques cannot be applied to an interactive system on the Internet or such system.

Provot [Provot X., Deformation constraints in a mass-spring model to describe rigid cloth behaviour, Proceedings of Graphics Interface 1995; 141-155] suggested a mass-spring model to describe rigid cloth behaviour, which proved to be faster than the techniques described above and easy to implement. Its major drawback is super-elasticity which will be described in detail later in this document. In order to overcome this problem he applied a position modification algorithm to the ends of over-elongated springs. However, if this operation modifies the positions of many vertices, it may elongate other springs. That is why this approach is applicable only if deformation is locally distributed, which is not the case when simulating garments on a virtual body.

A further problem associated with prior art systems is collision detection and response. This proves to be a bottleneck in dynamic simulation techniques/systems that use highly discretised surfaces. So, if it is necessary to achieve good performance, efficient collision detection is essential. Most of the existing algorithms for detecting collisions between the cloth and other objects in a scene are based on geometrical object-space (OS) interference tests. Some apply a prohibitive energy field around the colliding objects, but most of them use geometric calculations to detect penetration between a cloth particle and a face of the object, together with optimisation techniques in order to reduce the number of checks.

The most common approaches are voxel or octree subdivision which are described by Badler N. I. and Glassner A. S., in their paper “3D object modelling”, Course note 12, Introduction to Computer Graphics. SIGGRAPH 1998; 1-14. The object space is subdivided either into an array of regular voxels or into a hierarchical tree of octants and detection is performed, exploring the corresponding structure. Another solution is to use a bounding box (BB) hierarchy such as that used by Baraff and Witkin, or Provot [Provot X., Collision and self-collision detection handling in cloth model dedicated to design garments, Proceedings of Graphics Interface 1997; 177-189]. Objects are grouped hierarchically according to proximity rules and a BB is pre-computed for each object. Collision detection is then performed by analysing BB intersections in the hierarchy. Other techniques exploit proximity tracking, such as that used by Pascal et al. [Pascal V., Magnenat-Thalmann N., Collision and self-collision detection: efficient and robust solution for highly deformable surfaces, Sixth Eurographics Workshop on Animation and Simulation 1995; 55-65] to reduce the big number of collision checks, excluding objects or parts which are unable to collide.

Recently, new techniques have been developed, based on image-space (IS) tests such as that proposed by Shinya et al. [Shinya M. and Forque M., Interference detection through rasterization. Journal of Visualization and Computer animation 1991; 2:131-134]. These techniques use the graphics hardware of the machine upon which they operate to render the scene, and then perform checks for interference between objects based on the depth map of the image. In this way the 3D problem is reduced to 2.5D. As a result of using the graphics hardware these approaches are very efficient. However, they have been mainly used to detect rigid object interference in CAD/CAM systems and in dental practice, but never for cloth-body collision detection and response.

As will be appreciated, there exist a number of problems in the area of simulating cloth and animating cloth on 3D bodies, as discussed above. It is the intention of the present invention to address one or more of these problems.

The method described here is based on an improved mass-spring model of cloth and a fast new algorithm for cloth-body collision detection. It reads as an input, a body file and a garment text file. The garment file describes the cutting pattern geometry and seaming information of a garment. The latter are derived from existing apparel CAD/CAM systems, such as GERBER. The cutting patterns are positioned around the body and elastic forces are applied along the seaming lines. After a certain number of iterations the patterns are seamed, i.e. the garment is “put on” the human body. Then gravity is applied and a body walk is animated.

However, the present method, introduces a new approach to overcome super-elasticity, which is named “velocity directional modification”. Instead of modifying the positions of end points of the springs that were already over-elongated, the present invention checks their length after each iteration and does not allow elongation of more than a certain threshold. This approach has been further developed and optimised for the dynamic case of simulating cloth (i.e. on moving objects), as will be described below.

The system of the present invention exploits an image-space approach to collision detection and response. Its main strength is that it uses workstation graphics hardware of the system upon which it is to be utilised not only to compute depth maps, which are necessary for collision detection as will be shown below, but also to generate maps of normal vectors and velocities for each point on the body. The latter are necessary for collision response as will also be shown below. As a result, the technique is very fast and the detection and response time do not depend on the number of faces on the human body.

In accordance with the present invention, there is provided a method of dressing one or more 3D virtual beings and animating the dressed beings for visualisation, the method comprising the steps of:
positioning one or more garment pattern around the body of a 3D virtual being;
applying, iteratively, to the pattern elastic forces in order to seam the garment; and
once the garment is seamed, causing the body to carry out one or more movements, wherein over-stretching of cloth within the garment is prevented by the modification of the velocity, in the direction of cloth stretch, of one or more points within the garment.

In a preferred embodiment, the method further includes the step of determining, after each application of elastic forces to the pattern, whether the garment is correctly seamed. Preferably, gravitational forces are applied to the garment prior to the body upon which it is fitted being caused to carry out movement.

In a preferred embodiment of the present invention, the cloth of the garment is modelled using a masses and springs model.

Preferably, the virtual body is caused to move by the production and presentation of consecutive images of the body, the images differing in position such that when presented consecutively the body carries out a movement sequence.

In accordance with a preferred embodiment of the present invention, the prevention of overstretching includes the steps of: after the generation of each image, determining for each spring within the garment whether the spring has exceeded its natural length by a predefined threshold; and for each spring that has exceeded its natural length, adjusting the velocity, parallel to the spring, of the mass point at one or both ends of the spring.

Preferably, velocity adjustments are calculated by: calculating a directional vector for the garment; calculating a spring directional vector; and determining an angle between the two vectors; then, if the spring is substantially perpendicular to the directional vector, modifying the velocity components at each end of, and parallel to, the spring such that they are each set to their mean value, otherwise setting the velocity component, parallel to the spring, of the rearmost end of the spring with regard to the calculated directional vector to equal that of the frontmost end. Preferably, the directional vector is calculated by determining the sum of the velocity of the object which the garment is covering and the velocity due to gravity of the garment. More preferably, the spring directional vector is calculated by determining the difference between the positions of the end points of the spring.

In accordance with a preferred embodiment of the present invention the method further includes the steps of: after the generation of each image, determining for each of a plurality of vertices or faces within the garment, whether a collision has occurred between the cloth and the body; and if a collision has occurred, generating and applying to the vertex or face the cloth's reaction to the collision. Preferably, the body is represented by a depth map in image-space, and collisions are determined by comparing the depth value of a garment point with the corresponding body depth information from the map.

Preferably, a face comprises a quadrangle on cloth, and is defined by its midpoint and velocity. More preferably, the face midpoint and velocity are defined by an average of the positions and velocities of the four vertices which form the face.

Preferably, the generation of the cloth's reaction includes the steps of: generating one or more normal map for the virtual body; generating one or more velocity map for the virtual body; and determining the relative velocity between garment and object. Preferably, the cloth's reaction is:
vᵣₑₛ=C_{fric}·vₜ−C_{refl}·vₙ+v_{object}
wherein C_{fric} and C_{refl} are friction and reflection coefficients which depend upon the materials of the colliding cloth and object, and vₜ and vₙ are the tangent and normal components of the relative velocity.

More preferably, the generation of the cloth's reaction includes, prior to the determination of the relative velocity: determining a reaction force for the cloth vertex; and adding the reaction force to the forces apparent upon the cloth vertex. Still more preferably, the reaction force is given by:
f_{reaction}=−C_{fric}fₜ−fₙ,
wherein C_{fric} is a frictional coefficient dependent upon the material of the cloth and fₜ and fₙ are the tangential and normal components of the force acting on the cloth vertex.

In accordance with a preferred embodiment of the present invention, a normal map is generated by substituting the [red, green, blue] depth map value of each vertex of the body with the co-ordinates of its corresponding normal vector, and interpolating between points to produce a smooth normal map. More preferably, a velocity map is generated by substituting the [red, green, blue] depth map value of each vertex within the mapped body with the co-ordinates of its velocity, and interpolating the velocities for all intermediate points. Still more preferably, substitution comprises representing the substituted co-ordinates as colour values.

Also in accordance with the present invention there is provided a method of dressing one or more 3D virtual beings and animating the dressed being for visualisation, the method comprising the steps of: positioning one or more garment pattern around the body of a 3D virtual being; applying, iteratively, to the pattern elastic forces in order to seam the garment; and once the garment is seamed, causing the body to carry out one or more movements, wherein collisions between the garment and body are detected and compensated for in image space, the body being represented by colour values.

Also in accordance with the present invention there is provided a system for dressing, animating and visualising 3D beings, comprising: a dressing and animation module; and at least one interaction and visualisation module, wherein at least one interaction and visualisation module is presented by a remote terminal and interacts with the dressing and animation module via the internet. Preferably, a 3D scanner is further included in the system, the scanner adapted to scan the body of a being, such as a human, and produce data representative thereof. More preferably, the data is image depth data. Still more preferably, the data produced by the scanner is output on a portable data carrier and/or output directly to memory associated with the dressing and animation module.

A specific embodiment of the present invention is now described, by way of example only, with reference to the accompanying drawings, in which:—

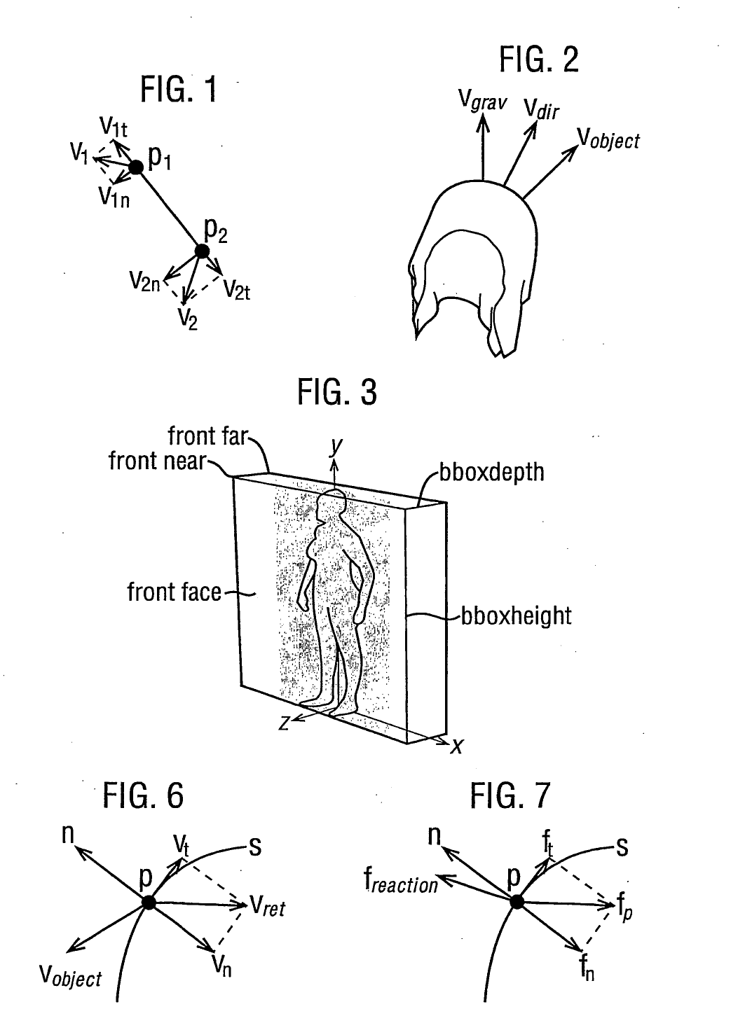

FIG. 1 shows an elongated spring and velocities associated with the ends thereof;

FIG. 2 shows a directional vector apparent upon an object;

FIG. 3 shows the positioning of cameras around a bounding box for rendering a body for use in the present invention;

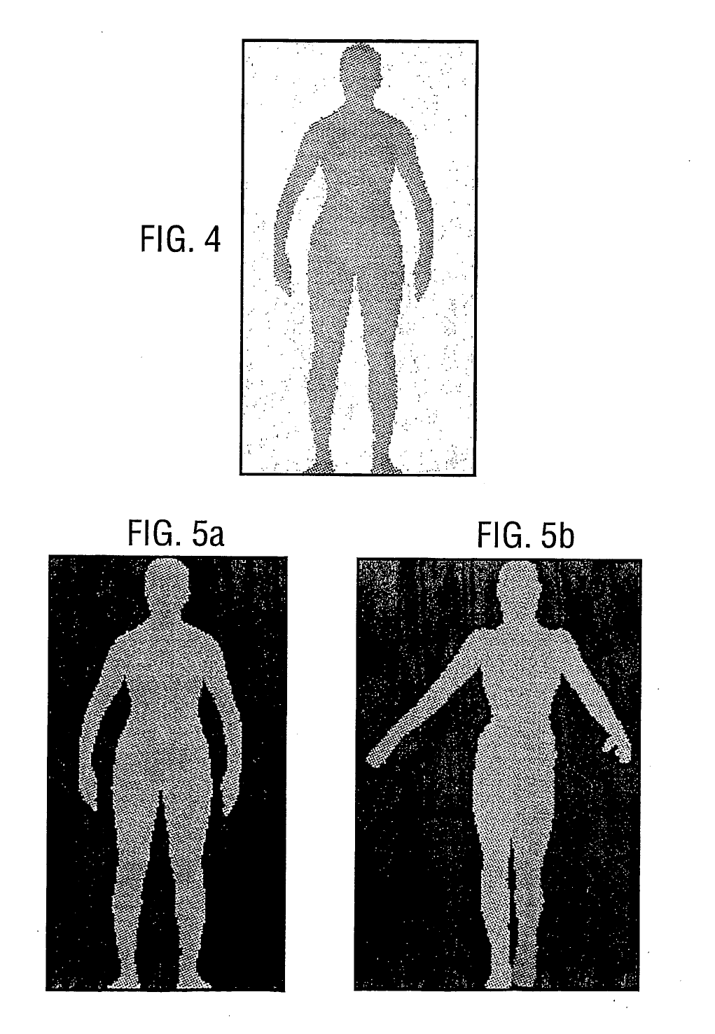

FIG. 4 shows a depth map generatable by the present invention;

FIG. 5a shows an example normal map;

FIG. 5b shows an example velocity map;

FIG. 6 shows the velocities apparent at a point on cloth during a collision with a moving object;

FIG. 7 shows the same situation as FIG. 6, with an additional reaction force introduced; and

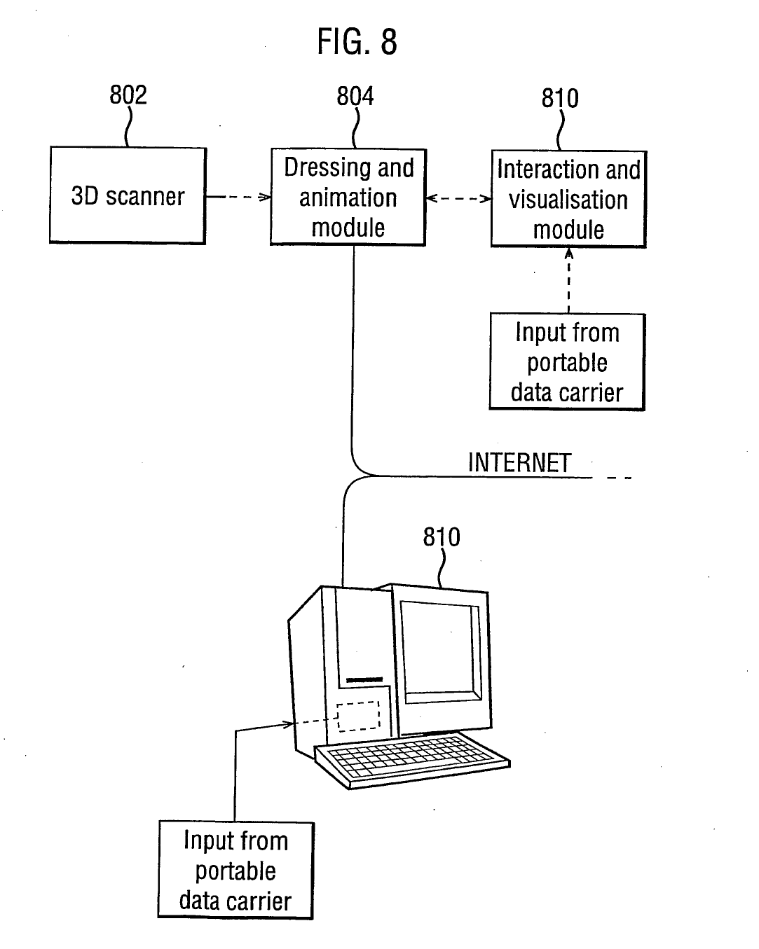

FIG. 8 shows a system for carrying out the method of the present invention.

Since the present invention simulates cloth using masses and springs, the original model suggested by Provot is described below.

The elastic model of cloth is a mesh of l×n mass points, each being linked to its neighbours by massless springs of natural length greater than zero. There are three different types of springs:
Springs linking vertices [i, j] with [i+1, j], and [i, j] with [i, j+1] are called “structural” or “stretching” springs;
Springs linking vertices [i, j] with [i+1, j+1], and [i+1, j] with [i, j+1) are called “shear springs”;
Springs linking vertices [i, j] with [i+2, j], and [i, j] with [i, j+2] are called “flexion springs”.

The first type of spring implements resistance to stretching, the second resistance to shearing and the third resistance to bending.

We let pᵢⱼ(t), vᵢⱼ(t) and aᵢⱼ(t), where i=1, . . . , l and j=1, . . . , n, be respectively the positions, velocities, and accelerations of the mass points in the model at time t. The system is governed by the basic Newton's law:
fᵢⱼ=maᵢⱼ (1)
where m is the mass of each point and fᵢⱼ, is the sum of all forces applied at point pᵢⱼ. The force fᵢⱼ can be divided into two categories; internal and external forces.

The internal forces are due to the tensions of the springs. The overall internal force applied at the point pᵢⱼ is a result of the stiffness of all springs linking this point to its neighbours:

$${f}_{int} ( {p}_{i j} ) = - {\sum }_{k , l} {k}_{i j k l} [ \overline{{p}_{k l} {p}_{i j}} - {l}_{i j k l}^{ 0} \frac{\overline{{p}_{k l} {p}_{i j}}}{‖ \overline{{p}_{k l} {p}_{i j}} ‖} ] \qquad ( 2 )$$

where kᵢⱼₖₗ is the stiffness of the spring linking pᵢⱼ and pₖₗ and

$${l}_{i j k l}^{ 0}$$
is the natural length of the same spring.

The external forces can differ in nature depending on what type of simulation we wish to model. The most frequent ones will be:
Gravity: f_{gr}(pᵢⱼ)=mg, where g is the acceleration due to gravity;
Viscous damping: f_{vd}(pᵢⱼ)=−C_{vd}vᵢⱼ, where C_{vd} is a damping coefficient.

All the above formulations make it possible to determine the force fᵢⱼ(t) applied on point pᵢⱼ at any time t. The fundamental equations of Newtonian dynamics can be integrated over time by a simple Euler method:

$$\vert \begin{matrix}\begin{matrix}{a}_{i j} ( t + Δ t ) = \frac{1}{m} {f}_{i j} ( t ) \\ {v}_{i j} ( t + Δ t ) = {v}_{i j} ( t ) + Δ t {a}_{i j} ( t + Δ t )\end{matrix} \\ {p}_{i j} ( t + Δ t ) = {p}_{i j} ( t ) + Δ t {v}_{i j} ( t + Δ t )\end{matrix} \qquad ( 3 )$$

where Δt is a chosen time step. More complicated integration methods, such as Runge-Kutta, can be applied to solve the differential equations. This, however, reduces the speed significantly, which is very important in the present invention. The Euler Equations are known to be very fast and give good results, when the time step Δt is less than the natural period of the system,

$${T}_{0} = π \sqrt{\frac{m}{K}} .$$
In fact our experiments showed that the numerical solution of Equation (3) is stable when:

$$Δ t \leq 0.4 π \sqrt{\frac{m}{K}} \qquad ( 4 )$$
where K is the highest stiffness in the system.

The major drawback of the mass-spring cloth model is its “super elasticity”. Super elasticity is due to the fact that the springs are “ideal” and they have an unlimited linear deformation rate. As a result, the cloth stretches even under its own weight, something that does not normally happen to real cloth.

As has already been elucidated, Provot proposed to cope with super-elasticity using position modification. His algorithm checks the length of each spring at each iteration and modifies the positions of the ends of the spring if it exceeds its natural length by more than a certain value (10% for example). This modification will adjust the length of some springs, but it might over-elongate others. So, the convergence properties of this technique are not clear. It proved to work for locally distributed deformations, but no tests were conducted for global elongation.

The main problem with the position modification approach is that it first allows the springs to over-elongate and it then tries to adjust their length by modifying positions. This, of course, is not always possible because of the many links between the mass points. The present inventors idea was to find a constraint that does not allow any over-elongation of springs.

The technique of the present invention works as follows. After each iteration (i.e. each step in the generation of the garment image), each spring is checked to determine whether it exceeds it natural length by a pre-defined threshold. If it does, the velocities apparent upon the spring are modified, so that further elongation is not allowed. The threshold value usually varies from 1% to 15% of the natural length of the spring, depending on the type of cloth we want to simulate.

Let p₁ and p₂ be the positions of the end points of a spring found as over-elongated, and v₁ and v₂ be their corresponding velocities, as shown in FIG. 1. The velocities v₁ and v₂ are split into two components v₁ₜ and v₂ₜ, along the line connecting p₁ and p₂, and v₁ₙ and v₂ₙ, perpendicular to this line. Obviously the components causing the spring to stretch are v₁ₜ and v₂ₜ, so they have to be modified. In general v₁ₙ and v₂ₙ could also cause elongation, but their contribution within one time step is negligible.

There are several possible ways of modification:
i) set both v₁ₜ and v₂ₜ to their average, i.e.
   v₁ₜ=v₂ₜ=0.5(v₁ₜ+v₂ₜ). (5)
ii) set only one of them equal to the other, but what criteria determine which one to change at the current simulation step?

It was found that equation 5 is good enough for the static case, i.e. when the cloth collides with static objects. So, if it is desired to implement a system for dressing static human bodies, equation 5 will be the obvious solution, because it produces good results and is the least expensive. For dynamic simulations, however, when objects in the scene are moving, the way in which the velocities are modified proves to have an enormous influence on cloth behaviour. For example, equation 5 gives satisfactory results for relatively low rates of cloth deformations and relatively slow moving objects. In faster changing scenes, it becomes clumsy and cannot give a proper response to the environment.

The following solution was devised. A vector called a “directional vector” which is computed as:
v_{dir}=v_{grav}+v_{object} (6)
is introduced. Such a vector is represented in FIG. 2. V_{object} is the velocity of the object which the cloth is colliding with, and v_{grav} is a component called “gravitational velocity” computed as v_{grav}=gΔt. The directional vector gives the direction in which higher spring deformation rates are most likely to appear at the current step of simulation, and in which the cloth should resist modification. The components of the directional vector are the sources which will cause cloth deformation. In the present case they are gravity and the velocity of the moving object. However, in other environments there might be other sources which have to be taken into account, such as wind for example.

Once the directional vector has been determined, the velocities are modified in the following way. Let p₁₂=p₂−p₁ be the spring directional vector and a be the angle between p₁₂ and v_{dir}. The cosine of a can be easily computed as a scalar product of the two vectors.

Then, if the spring is approximately perpendicular to the directional vector v_{dir} (i.e. |cos α|<0.3), both velocities v₁ₜ and v₂ₜ are modified using the relationship of equation 5.

However, if the spring is not approximately perpendicular to the directional vector, the velocity of the rear point (considering the directional vector) is made equal to the front one, so that it can “catch up” with the changing scene. So, if cos α>0 then v₁ₜ=v₂ₜ, else v₂ₜ=v₁ₜ

If this is applied to all springs, the stretching components of the velocities are removed and in this way further stretching of the cloth is not allowed. In addition, the “clumsiness” of the model is eliminated and it reacts adequately to moving objects. This approach works for all types of deformation: local or global, static or dynamic.

As has been set forth above, collision detection is one of the crucial parts in fast cloth simulation. At each simulation step, a check for collision between the cloth and the human model has to be performed for each vertex of the garment. If a collision between the body and a cloth vertex is found, the response to that collision needs to be calculated. In the present invention there is implemented an image-space based collision detection approach. Using this technique it is possible to find a collision by comparing the depth value of the garment point with the according depth information of the body stored in depth maps. The present inventors went even further and elected to use the graphics hardware of the system implementing the technique to generate the information needed for collision response, that is the normal and velocity vectors of each body point. This can be done by encoding vector co-ordinates (x, y, z) as colour values (R, G, B). Depth, normal and velocity maps are created using two projections: one of the front and one of the back of the model. For rendering the maps, two orthogonal cameras are placed at the centre of the front and the back face of the body's BB. To increase the accuracy of the depth values, the camera far clipping plane is set to the far face of the BB and the near clipping plane is set to near face of the BB. Both cameras point at the centre of the BB. This is illustrated in FIG. 3. The maps are generated at each animation step, although if the body movements are known, they can be pre-computed.

Note that it is not necessary to generate the velocity maps if we simulate cloth colliding with static objects, because their velocities are zero. So, when the virtual body is dressed with garment, velocity maps are not rendered, which speeds up the simulation.

When initialising the simulation of the dressed body we execute two off-screen renderings to retrieve the depth values, one for the front and one for the back. The z-buffer of the graphics hardware is moved to main memory using OpenGL's buffer-read function. The z-buffer contains floating-point values from 0.0 to 1.0. A value of 0.0 represents a point at the near clipping plane and 1.0 stands for a point at the far clipping plane. FIG. 4 shows an example depth map.

During the two renderings for generating the depth maps, the normal maps are also computed. To do this, the (Red, Green Blue) value of each vertex of the 3D model is substituted with the coordinates (nₓ, n_{y}, n_{z}) of its normal vector n. In this way the frame-buffer contains the normal of the surface at each pixel represented as colour values. Since the OpenGL colour fields are in a range from 0.0 to 1.0 and normal values are from −1.0 to 1.0 the coordinates are converted to fit into the colour fields using the equation:

$$[ \begin{matrix}\begin{matrix}Red \\ Green\end{matrix} \\ Blue\end{matrix} ] = 0.5 n + [ \begin{matrix}\begin{matrix}0.5 \\ 0.5\end{matrix} \\ 0.5\end{matrix} ] \qquad ( 7 )$$

The graphics hardware is used to interpolate between the normal vectors for all intermediate points. Using OpenGL's read-buffer function to move the frame buffer into main memory gives us a smooth normal map. Conversion from (Red, Green, Blue) space into the normal space is then achieved by using the relationship:

$$n = 2 [ \begin{matrix}\begin{matrix}Red \\ Green\end{matrix} \\ Blue\end{matrix} ] - [ \begin{matrix}\begin{matrix}1 \\ 1\end{matrix} \\ 1\end{matrix} ] \qquad ( 8 )$$

FIG. 5a shows an example normal map.

Similarly to the rendering of the normal maps, the (Red, Green, Blue) value of each vertex of the 3D model is substituted with the coordinates (vₓ, v_{y}, v_{z}) of its velocity v in order to render velocity maps. Since the velocity coordinate values range from −maxv to +maxv, they are converted to fit into the colour fields using the relationship:

$$[ \begin{matrix}\begin{matrix}Red \\ Green\end{matrix} \\ Blue\end{matrix} ] = 0.5 v + [ \begin{matrix}\begin{matrix}0.5 / maxv \\ 0.5 / maxv\end{matrix} \\ 0.5 / maxv\end{matrix} ] \qquad ( 9 )$$

Again the graphics hardware is utilised to interpolate the velocities for all intermediate points. The conversion from (Red, Green, Blue) space into the velocity space is determined as follows:

$$v = maxv ( 2 [ \begin{matrix}\begin{matrix}Red \\ Green\end{matrix} \\ Blue\end{matrix} ] - [ \begin{matrix}\begin{matrix}1 \\ 1\end{matrix} \\ 1\end{matrix} ] ) \qquad ( 10 )$$

FIG. 5b shows an example velocity map.

After retrieving depth, normal and velocity maps, testing for and responding to collisions can be carried out very efficiently. If it is desired to know whether a point (x, y, z) on the cloth collides with the body, the point's x, y values need to be converted from the world coordinate system into the map coordinate system (X, Y,) as shown:

$$\begin{matrix}Y = \frac{y * mapsize}{bboxheight} , \\ {X}_{back} = [ 1 - \frac{x + \frac{bboxheight}{2}}{bboxheight} ] * mapsize , \\ {X}_{front} = [ \frac{x + \frac{bboxheight}{2}}{bboxheight} ] * mapsize\end{matrix} \qquad ( 11 )$$

First the z value is used to decide which map to use: the back one or the front one. The corresponding z value of the depth map is compared with the z value of the pixel's coordinates using:
back: z<depthmap(X_{back, Y)}
front: z>depthmap(X_{front}, Y) (12)

If a collision occurred, the normal and velocity vectors are retrieved from the colour maps indexed by the same coordinates (X, Y) used for the collision check. These vectors are necessary to compute a collision response.

Considering the fact that most modern workstations use a 24 bit z-buffer and that bboxdepth<100 cm for an average person then the following estimate applies for discretisation error in z:

$$Δ z = \frac{bboxdepth}{{2}^{24}} < \frac{100}{{2}^{24}} < {6.10}^{- 6} cm . \qquad ( 13 )$$

This is more than enough in the present case, bearing in mind that the discretisation error of the 3D scanner is of the order of several millimetres. The errors in x and y are equal and can be computed as:

$$Δ x = Δ y = \frac{bboxheight}{mapsize} \approx \frac{160 to 180}{mapsize} cm \qquad ( 14 )$$

where the average person is considered to be 160 to 180 cm tall. This means that we have control over the error in the x and y direction by varying the size of the maps. However, bigger map size also means bigger overhead, as buffer retrieval times will be higher. A reasonable trade-off is Δx=Δy=0.5 cm, so mapsize=320 to 360 pixels.

After a collision has been detected, the algorithm has to compute a proper response for the whole system. The present approach does not introduce additional penalty, gravitational or spring forces; it just manipulates the velocities.

Let v be the velocity of the point p colliding with the object s and let v_{object} be the velocity of this object, as shown in FIG. 6. The surface normal vector at the point of collision is denoted by n. First, the relative velocity between the cloth and the object has to be computed as vᵣₑₗ=v−v_{object}. If vₜ and vₙ are the tangent and normal components of the relative velocity vᵣₑₗ, then the resultant velocity can be computed as:
vᵣₑₛ=C_{fric}vₜ−C_{refl}vₙ+v_{object}, (15)
where C_{fric} and C_{refl} are a friction and a reflection coefficients, which depend on the material of the colliding objects.

A similar approach can be implemented to detect and find the responses not only to vertex-body, but also to face-body collisions between garment and body. For each quadrangle on the cloth the midpoint and velocity are computed as an average of the four adjacent vertices. Collision of this point with the body is then checked for and, if such occurred, the point's response is computed using equation 15. The same resultant velocity is applied to the surrounding four vertices. However, if there is more than one response for a vertex, an average velocity is calculated for this vertex. This approach helps to reduce significantly the number of vertices, which speeds up the whole method.

Tests sometimes showed that the velocity collision response did not always produce satisfactory results. For example, when heavy cloth was simulated there were penetrations in the shoulder areas. In order to make the collision response smoother, an additional reaction force was introduced for each colliding point on the cloth, as shown in FIG. 7.

Let fₚ be the force acting on the cloth vertex p. If there is a collision between p and an object in the scene s, then fₚ is split into its two components: normal (fₙ) and tangent (fₜ). The object reaction force is then computed.
f_{reaction}=−C_{fric}fₜ−fₙ, (16)
where the first component is due to the friction and depends on the materials.

Reaction force can also be computed to respond to collisions face-body in the same way as described for the velocities above.

The reaction force is used in collision detection as follows. When a collision has been detected for a specific cloth vertex, the reaction force, shown above in equation 16, is determined. This force is added to what is termed the integral force of the specific cloth vertex. The integral force is given by the sum of the spring forces on the vertex, gravity, elastic forces (applied at the seams) acting upon the vertex, air resistance and, after the above stage, the reaction force for the specific vertex.

After the integral force has been updated to include the reaction force, the acceleration of each cloth-mass point and the velocity of each such point is determined. The velocities are then modified in the manner described above, the corresponding collision responses are determined, as set forth in equation 15 above, and the new position for each mass point is then determined.

A system which carries out the method described above will now be described with reference to FIG. 8. The system illustrated incorporates a number of modules. However, as will be described, not all modules are essential to its operation. Various combinations of module can be utilised to create different embodiments of the system.

Firstly, there is provided a 3D scanner 802. The scanner may be a stand alone module, which outputs a scan on a portable data carrier. Alternatively, the scanner may be directly connected to a dressing and animation module 804. Of course, the scanner 802 may be configured in both of the above ways at once.

The scanner 802 is a body scanner which produces a body file of a person who undergoes scanning. The body file so generated may then be utilised in the system of the present invention, such that the dressed image visualised by the customer/user is an image of their own body when dressed. This is an important feature, since it allows the customer/user to determine how well particular garments fit their body, and how garment shapes suit their body shape.

The dressing and animation module 804 which may incorporate memory 806 (not shown) or may be connected to an external source of memory 808 (not shown), utilises the scanned body information, garment and seaming information to carry out the method described above. As already stated, the scanned body information may be supplied to this module 804 directly from the scanner 802 and stored in memory 806,808. The garment and seaming information will also be stored in memory 806,808.

There is an interaction and visualisation module 810, which is in connection with the dressing and animation module 804. This provides an interface through which the customer/user may access the dressing and animation module, dress their scanned body in garments chosen from those available, and visualise their body dressed and carrying out movements, such as walking along a catwalk. The interaction and visualisation module 810 may also provide a facility for ordering or purchasing selected garments, by the provision of shopping basket facilities, for example.

The interaction and visualisation module 810 may enable a customer/user to access their scanned body from the memory 806, 808 within the system. Alternatively, it may provide means for reading a portable data carrier upon which is stored the customer/user's scanned body information—produced by the scanner 802.

As will be appreciated from FIG. 8, the interaction and visualisation module 810 may take the form of a dedicated terminal which may be located in a retail outlet, or may take the form of an interface accessible and useable, via the internet or analogous means, using a home computer, for example.

In an alternative embodiment of the system (not shown), the dressing and animation module may be located, with the interaction and visualisation module, in a dedicated terminal, accessible via the internet or in a user terminal. In this instance, only the body and garment information are downloaded from a memory provided within a server. As will be appreciated, the dressing and animation of the body are carried out locally, i.e. in the user terminal for example.

It will of course be understood that the present invention has been described above by way of example only, and that modifications of detail can be made within the scope of the invention.

1. A method of dressing 3D virtual beings and animating the dressed beings for visualisation, the method comprising the steps of:
positioning one or more garment pattern around a body of a 3D virtual being;
applying, iteratively, to the pattern elastic forces in order to seam the garment; and
once the garment is seamed, causing the body to carry out one or more movements,
wherein overstretching of cloth within the garment is prevented by the modification of the velocity, in the direction of cloth stretch, of one or more points within the garment.

2. A method as claimed in claim 1, further including the step of determining, after each application of elastic forces to the pattern, whether the garment is correctly seamed.

3. A method as claimed in claim 1 or claim 2, wherein gravitational forces are applied to the garment prior to the body upon which it is fitted being caused to carry out movement.

4. A method as claimed in any preceding claim, wherein the cloth of the garment is modelled using a masses and springs model.

5. A method as claimed in any preceding claim, wherein the virtual body is caused to move by the production and presentation of consecutive images of the body, the images differing in positioning such that when presented consecutively the body carries out a movement sequence.

6. A method as claimed in claim 5, wherein the prevention of overstretching includes the steps of:
after the generation of each image, determining for each spring within the garment whether the spring has exceeded its natural length by a pre-defined threshold; and
for each spring that has exceeded its natural length, adjusting the directional velocity of the mass point at one or both ends of the spring.

7. A method as claimed in claim 6, wherein velocity adjustments are calculated by:
calculating a directional vector for the garment by determining the sum of the velocity of the object which the garment is covering and the velocity due to gravity of the garment;
calculating a spring directional vector; and
determining an angle between the two vectors;
wherein, if the spring is perpendicular to the directional vector, the velocity components at each end and parallel to the spring are modified, such that they are each set to their mean value; otherwise the velocity component, parallel to the spring, of the rearmost end of the spring with regard to the calculated directional vector is set equal to that of the frontmost end.

8. A method as claimed in claim 7, wherein the spring directional vector is calculated by determining the difference between the positions of the end parts of the spring.

9. A method as claimed in any preceding claim, further including the steps of:
after the generation of each image, determining for each of a plurality of vertices or faces within the garment, whether a collision has occurred between the cloth and the body; and
if a collision has occurred, generating and applying to the vertex or face the cloth's reaction to the collision.

10. A method as claimed in claim 9, wherein a face comprises a quadrangle on cloth, and the face midpoint and velocity are an average of those values for the four surrounding vertices.

11. A method as claimed in claim 9 or 10, wherein the body is represented by a depth map in image-space, and collisions are determined by comparing the depth value of a garment point with the corresponding body depth information from the map.

12. A method as claimed in any of claims 9 to 11, wherein generating the cloth's reaction includes the steps of:
generating one or more normal map for the virtual body;
generating one or more velocity map for the virtual body; and
determining the relative velocity between garment and object.

13. A method as claimed in claim 12, wherein the cloth's reaction is determined by the relationship:
vᵣₑₛ=C_{fric}·vₜ−C_{refl}·vₙ+V_{object}
wherein C_{fric} and C_{refl} are friction and reflection coefficients which depend upon the materials of the colliding cloth and object, and vₜ and vₙ are the tangent and normal components of the relative velocity.

14. A method as claimed in claim 12, further including, prior to the determination of the relative velocity, the steps of:
determining a reaction force for the cloth vertex; and
adding the reaction force to the forces apparent upon the cloth vertex.

15. A method as claimed in claim 14, wherein the reaction force is given by:
f_{reaction}=−C_{fric}fₜ−fₙ,
wherein C_{fric} is a frictional coefficient dependent upon the material of the cloth and fₜ and fₙ are the tangential and normal components of the force acting on the cloth vertex.

16. A method as claimed in either claim 12 or claim 13, wherein a normal map is generated by substituting a [Red, Green, Blue] depth map value of each vertex of the body with co-ordinates of its corresponding normal vector, and interpolating between points to produce a smooth normal map.

17. A method as claimed in any of claims 12 to 16, wherein a velocity map is generated by substituting [Red, Green Blue] depth map value of each vertex within the mapped body with the co-ordinates of its velocity, and interpolating the velocities for all intermediate points.

18. A method as claimed in either of claims 16 or 17, wherein substitution comprises representing the substituted coordinates as colour values.

19. A method of dressing 3D virtual beings and animating the dressed beings for visualisation, the method comprising the steps of:
positioning one or more garment pattern around a body of a 3D virtual being;
applying, iteratively, to the pattern elastic forces in order to seam the garment; and
once the garment is seamed, causing the body to carry out one or more movements,
wherein collisions between the garment and body are detected and compensated for in image-space, vector co-ordinates of the body being represented by colour values to enable body normal and velocity vectors to be generated by graphics hardware.

20. A method substantially as hereinbefore described with reference to and as shown in the accompanying drawings.

21. A system configured to carry out the method of any preceding claim.

22. A system as claimed in claim 21, wherein visualisation of the dressed and animated body takes place at a terminal remote from a server carrying out the method.

23. A system as claimed in claim 22, wherein communication between the terminal and the server is via the internet, or other analogous means.

24. A system substantially as hereinbefore described with reference to and as shown in the accompanying drawings.

25. A computer program product comprising a computer readable medium having stored thereon computer program means for causing a computer to carry out the method of any of claims 1 to 20.
